(19) United States
(12) Patent Application Publication
(10) Pub. No.: US 2014/0354673 A1
(43) Pub. Date: Dec. 4, 2014

(54) METHOD AND SYSTEM FOR SIMULATING REAL-TIME PROCESSING OF VIRTUAL SCENE

(71) Applicant: TENCENT TECHNOLOGY (SHENZHEN) COMPANY LIMITED, SHENZHEN (CN)

(72) Inventor: Xi Wang, Shenzhen (CN)

(21) Appl. No.: 14/448,632

(22) Filed: Jul. 31, 2014

Related U.S. Application Data
(63) Continuation of application No. PCT/CN2014/077988, filed on May 21, 2014.

(30) Foreign Application Priority Data
Jun. 3, 2013 (CN) 2013102162218

(51) Int. Cl. G06T 11/60; G06T 11/00

(52) U.S. Cl. CPC G06T 11/60; G06T 11/001
USPC 345/589; 345/629

(57) ABSTRACT

Aspects of the invention are directed to method and system for simulating real-time processing of a virtual scene. The method includes acquiring a virtual scene; adding an effect to the virtual scene, and acquiring an effect scene; and invoking the effect scene so as to simulate real-time processing of the virtual scene. According to the invention, before the virtual scene is invoked, effect processing is performed on the virtual scene in advance according to effect requirements. When the virtual scene is invoked, an effect resulting from real-time processing of the virtual scene is simulated. Since there is no need for the computer where the computer game is played to perform processing in real time, the computer is not required to have very high performance capability to simulate real-time processing. Further, the virtual scene can be shown smoothly in a computer without very high performance configuration.

### CROSS-REFERENCE TO RELATED APPLICATIONS

This application is a continuation application of International Patent Application No. PCT/CN2014/077988, entitled “Method and System for Simulating Real-Time Processing of Virtual Scene”, by Xi WANG, filed on May 21, 2014, by, which itself claims the priority to Chinese Patent Application No. 201310216221.8, entitled “Method and System for Simulating Real-Time Processing Of Virtual Scene”, by Xi WANG, filed on Jun. 3, 2013 in the State Intellectual Property Office of P.R. China, which are hereby incorporated herein in their entireties by reference.

### FIELD OF THE INVENTION

The present invention relates generally to real-time processing of a virtual scene, and more particularly, to method and system for simulating real-time processing of a virtual scene, and a non-transitory computer-readable medium storing instructions which, when executed by one or more processors, cause the system to perform the method for simulating real-time processing of the virtual scene.

### BACKGROUND OF THE INVENTION

The background description provided herein is for the purpose of generally presenting the context of the present invention. Work of the presently named inventors, to the extent it is described in this background section, as well as aspects of the description that may not otherwise qualify as prior art at the time of filing, are neither expressly nor impliedly admitted as prior art against the present invention.

A virtual scene refers to a digital scene outlined by a computer through digital communication technologies, and generally includes virtual models. According to requirements of showing effect of the virtual scene, the computer performs effect processing on the virtual models while invoking the virtual scene to show effect of the virtual scene.

Conventionally, in order to meet the effect requirements, the computer is required to process the virtual models in the virtual scene in real time. Such real-time processing of the virtual models in the virtual scene requires high performance computer configurations, such as high CPU speed, large memory, high speed display card, large storage space, and great CPU processing power. Especially for video games, if the computer does not have sufficient processing power, the quality of virtual scene display will suffer.

Therefore, a heretofore unaddressed need exists in the art to address the aforementioned deficiencies and inadequacies.

### SUMMARY OF THE INVENTION

Certain aspects of the present invention are directed to method and system for simulating real-time processing of a virtual scene, and a non-transitory computer-readable medium storing instructions which, when executed by one or more processors, cause the system to perform the method for simulating real-time processing of the virtual scene. According to the invention, the computer does not need to perform processing in real time, the configuration requirements on the computer are low, and an effect achieved through real-time processing is simulated. Moreover, the virtual scene can be shown smoothly in a computer with low configuration.

In one aspect of the present invention, the method for simulating real-time processing of a virtual scene includes acquiring a virtual scene; adding an effect to the virtual scene, and acquiring an effect scene; and invoking the effect scene so as to simulate real-time processing of the virtual scene.

In one embodiment, the step of adding the effect to the virtual scene, and acquiring the effect scene includes uniformly setting an effect parameter value for the virtual scene according to requirements; and adding an effect to the virtual scene according to the effect parameter value, and acquiring the effect scene.

In one embodiment, the step of adding an effect to the virtual scene, and acquiring the effect scene includes acquiring virtual models in the virtual scene; acquiring types of the virtual models;grouping the virtual models according to the types, and then obtaining at least one virtual model group; and adding an effect to each virtual model in the virtual model group, and acquiring the effect scene.

In one embodiment, the step of adding an effect to each virtual model in the virtual model group, and acquiring the effect scene includes acquiring the virtual models in the virtual model group; and adding a color effect to the virtual models, and acquiring an effect scene.

In one embodiment, the method further includes acquiring virtual models in the virtual scene; acquiring combinable maps corresponding to the virtual models; and combining the combinable maps into one map.

In one embodiment, the method is applicable in a computer game.

In one aspect, the invention relates to a computer game rendered according to the above disclosed method.

In another aspect of the present invention, the system for simulating real-time processing of a virtual scene includes a first acquiring module, configured to acquire any virtual scene; an effect module, configured to add an effect to the virtual scene, and acquire an effect scene; and an invoking module, configured to invoke the effect scene, so as to simulate real-time processing of the virtual scene.

In one embodiment, the effect module includes a first setting sub-module, configured to uniformly set an effect parameter value for the virtual scene according to requirements; and a first effect sub-module, configured to add an effect to the virtual scene according to the effect parameter value, and acquire an effect scene.

In one embodiment, the effect module includes a first acquiring sub-module, configured to acquire virtual models in the virtual scene; a second acquiring sub-module, configured to acquire types of the virtual models; a grouping sub-module, configured to group the virtual models according to the types, and then obtain at least one virtual model group; and a second effect sub-module, configured to add an effect to each virtual model in the virtual model group, and then obtain an effect scene.

In one embodiment, the second effect sub-module includes a third acquiring sub-module, configured to acquire the virtual models in the virtual model group; and a third effect sub-module, configured to add a color effect to the virtual models, and acquire an effect scene.

In one embodiment, the system further includes a second acquiring module, configured to acquire virtual models in the virtual scene; a third acquiring module, configured to acquire combinable maps corresponding to the virtual models; and a combining module, configured to combine the combinable maps into one map.

In one embodiment, the system is applied in a computer game.

In a further aspect, the present invention, the non-transitory computer-readable medium stores instructions which, when executed by one or more processors, cause the system to perform the method for simulating real-time processing of a virtual scene.

According to embodiments of the invention, before a virtual scene is invoked, the virtual scene is first acquired; then, an effect is added to the virtual scene, and an effect scene is acquired subsequently; and finally, the effect scene added with the effect is directly invoked, so as to simulate a real-time processing procedure of the virtual scene. In comparison with the prior art, in the invention, before the virtual scene is invoked, effect processing is performed on the virtual scene in advance according to effect requirements, and when the virtual scene is invoked, an effect, achieved through real-time processing, of the virtual scene is simulated. According to the invention, since the computer does not need to perform processing in real time, the configuration requirements on the computer are low, and an effect achieved through real-time processing is simulated. Moreover, the virtual scene can be shown smoothly in a computer with low configuration.

These and other aspects of the present invention will become apparent from the following description of the preferred embodiment taken in conjunction with the following drawings, although variations and modifications therein may be effected without departing from the spirit and scope of the novel concepts of the invention.

### BRIEF DESCRIPTION OF THE DRAWINGS

The accompanying drawings illustrate one or more embodiments of the invention and, together with the written description, serve to explain the principles of the invention. Wherever possible, the same reference numbers are used throughout the drawings to refer to the same or like elements of an embodiment. The drawings do not limit the present invention to the specific embodiments disclosed and described herein. The drawings are not necessarily to scale, emphasis instead being placed upon clearly illustrating the principles of the present invention.

FIG. 1 is a flow chart of a method for simulating real-time processing of a virtual scene according one embodiment of the present invention.

FIG. 2 is a flow chart of a method for simulating real-time processing of a virtual scene in a computer game according to another embodiment of the present invention.

FIG. 3 is a flow chart of adding an effect to a virtual scene in a computer game through 3DMAX software according to another embodiment of the present invention.

FIG. 4 is a structural diagram of a system for simulating real-time processing of a virtual scene according to one embodiment of the present invention.

### DETAILED DESCRIPTION OF THE INVENTION

The following description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. For purposes of clarity, the same reference numbers will be used in the drawings to identify similar elements.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. The use of examples anywhere in this specification, including examples of any terms discussed herein, is illustrative only, and in no way limits the scope and meaning of the disclosure or of any exemplified term. Likewise, the disclosure is not limited to various embodiments given in this specification.

As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise.

As used herein, the phrase “at least one of A, B, and C” should be construed to mean a logical (A or B or C), using a non-exclusive logical OR. It should be understood that one or more operations within a method is executed in different order (or concurrently) without altering the principles of the present disclosure.

As used herein, the term “module” may refer to, be part of, or include an Application Specific Integrated Circuit (ASIC); an electronic circuit; a combinational logic circuit; a field programmable gate array (FPGA); a processor (shared, dedicated, or group) that executes code; other suitable hardware components that provide the described functionality; or a combination of some or all of the above, such as in a system-on-chip. The term module may include memory (shared, dedicated, or group) that stores code executed by the processor.

The term “code”, as used herein, may include software, firmware, and/or microcode, and may refer to programs, routines, functions, classes, and/or objects. The term “shared”, as used herein, means that some or all code from multiple modules is executed using a single (shared) processor. In addition, some or all code from multiple modules is stored by a single (shared) memory. The term “group”, as used herein, means that some or all code from a single module is executed using a group of processors. In addition, some or all code from a single module is stored using a group of memories.

It should be noted that terms such as first and second, and the like may be used solely to distinguish one entity or action from another entity or action without necessarily requiring or implying any actual such relationship or order between such entities or actions. The terms, “comprises” and/or “comprising”, or “includes” and/or “including” or “has” and/or “having” when used in this specification, are intended to cover a non-exclusive inclusion, such that a process, method, article, or apparatus that comprises a list of elements does not include only those elements but may include other elements not expressly listed or inherent to such process, method, article, or apparatus. An element preceded by “comprises” or “comprising”, or “includes” or “including” or “has” or “having” does not, without more constraints, preclude the existence of additional identical elements in the process, method, article, or apparatus that comprises the element.

The systems and methods described herein are implemented by one or more computer programs executed by one or more processors. The computer programs include processor-executable instructions that are stored on a non-transitory tangible computer readable medium. The computer programs may also include stored data. Non-limiting examples of the non-transitory tangible computer readable medium are nonvolatile memory, magnetic storage, and optical storage.

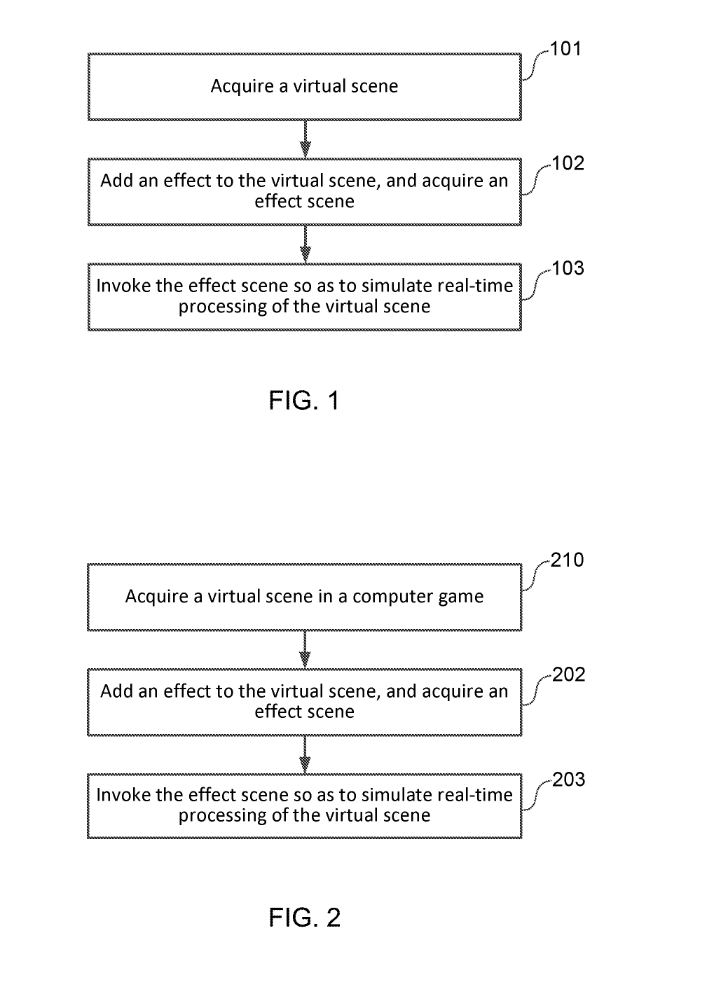

Embodiments of the present invention are illustrated in detail hereinafter with reference to accompanying drawings in FIGS. 1-4. It should be understood that specific embodiments described herein are merely intended to explain the present invention, but not intended to limit the present invention. Obviously, the embodiments to be described are part of rather than all of the embodiments of the present invention. All other embodiments made by persons skilled in the art based on the embodiments of the present invention without creative efforts shall fall within the protection scope of the present invention. In accordance with the purposes of this invention, as embodied and broadly described herein, this invention, in certain aspects, relates to method and system for simulating real-time processing of virtual scene, and a non-transitory computer-readable medium storing instructions which, when executed by one or more processors, cause the system to perform the method for simulating real-time processing of virtual scene.

In one aspect, the present invention relates to a method for simulating real-time processing of virtual scene without having high demands for the computer's performance capability. In certain embodiments, the effect of the virtual scene is processed in advance. When the virtual scene is invoked, the virtual scene has been processed and ready to be invoked. Accordingly, a system for simulating the real-time processing of the virtual scene does not require higher performance configuration.

### Embodiment 1

Conventionally, in a procedure of invoking a virtual scene, effect processing is performed on virtual models in the virtual scene, so as to meet requirements on a showing effect of the virtual scene. Since the real-time processing in the prior art has very strict requirements on the computer configuration, a method for processing the effect of the virtual scene in real time is not applicable to a computer with low configuration. However, according to this exemplary embodiment of the invention, the effect of the virtual scene is processed in advance, and when the virtual scene is invoked, a virtual scene undergoing processing is directly invoked. In this way, a real-time processing procedure of the virtual scene can also be simulated and completed without the need of high computer configuration.

Referring to FIG. 1, a flow chart of a method for simulating real-time processing of a virtual scene is shown according to Embodiment 1 of the invention. The method includes the following steps.

At step 101, a virtual scene is acquired.

In one embodiment, before processing the virtual scene, a virtual scene is first acquired and is taken as a processing object. The virtual scene may be any one virtual scene in a computer game. The specific type of the virtual scene can be any types, and is not limited to a specific type.

At step 102, an effect to the virtual scene is added, and an effect scene is acquired.

In one embodiment, an effect is added to the acquired virtual scene. After the effect is successfully added, an effect scene with a certain effect is acquired, where the effect scene is a virtual scene added with the effect.

In operation, the step of adding the effect to the virtual scene may be adjusting the color or the brightness of the virtual scene. The specific effect type can be any types, and is not limited to a specific type.

In one embodiment, an effect parameter value can be uniformly set for the virtual scene according to the requirements. When an effect needs to be set for the virtual scene, it is merely required to add the effect to the virtual scene according to the preset effect parameter value. Compared with the method in the prior art which an effect parameter value is set for each virtual model in the virtual scene, the invention method according to this embodiment can improve the efficiency of acquiring the effect scene. In certain embodiments, the operating procedure may be performed as follows: first, an effect parameter value is uniformly set for the virtual scene according to the requirements, and then, an effect is added to the virtual scene according to the effect parameter value, and an effect scene is acquired subsequently.

In certain embodiments, the method first groups the virtual models in the virtual scene; then an effect is added to each grouped virtual model; and finally, a virtual scene added with the effect, that is, an effect scene, is acquired.

Meanwhile, the method for grouping the virtual models in the virtual scene may be performed as follows: first acquiring types of the virtual models, and then the virtual models are grouped according to the types, and at least one virtual model group is obtained subsequently. Since the effect can be added in the same manner to the virtual models of the same type, the effect adding procedure can be simplified by grouping the virtual models according to their types. Specifically, the process according to this embodiment does not limit the method for grouping the virtual models in the virtual scene.

In addition, the type of the effect added to the virtual models in the virtual model group may be a color effect. In one embodiment, the virtual models in the virtual model group may be first acquired, and then, the color effect is added to the virtual model and an effect scene is acquired subsequently.

In one embodiment, the virtual models in the virtual scene are generally stored in the form of multiple maps. Since a large number of maps exist, the maps occupy a large memory. In order to save the memory, in one embodiment, combinable maps among the multiple maps corresponding to the virtual models are combined into one map, so as to achieve the objective of saving the memory.

In one embodiment, the virtual models in the virtual scene are first acquired; then the combinable maps corresponding to the virtual models are acquired; and finally, the combinable maps are combined into one map.

At step 103, the effect scene is invoked so as to simulate real-time processing of the virtual scene.

In one embodiment, when the virtual scene needs to be invoked, the effect scene, that is, the virtual scene added with the effect, is directly invoked. Accordingly, the real-time processing of the virtual scene is simulated and completed.

In one embodiment, several virtual scenes are processed in advance, so as to obtain several corresponding effect scenes. When the real-time processing of the virtual scene needs to be simulated, it is merely required to directly invoke a required effect scene in the several effect scenes.

In one embodiment, before a virtual scene is invoked, the virtual scene is first acquired. Then, an effect is added to the virtual scene, and an effect scene is acquired subsequently. Finally, the effect scene added with the effect is directly invoked, so as to simulate a real-time processing procedure of the virtual scene. According to the invention, before the virtual scene is invoked, effect processing is performed on the virtual scene in advance according to effect requirements. When the virtual scene is invoked, an effect resulting from real-time processing of the virtual scene is simulated. In certain embodiments, since there is no need for the computer where the computer game is played to perform processing in real time, the computer is not required to have very high performance capability to simulate real-time processing. The virtual scene can be shown smoothly in a computer without very high performance configuration.

### Embodiment 2

FIG. 2 is a flow chart of a method for simulating real-time processing of a virtual scene in a computer game according to Embodiment 2 of the invention. The method includes the following steps.

At step 201, a virtual scene in a computer game is acquired.

At step 202: an effect to the virtual scene is added, and an effect scene is acquired.

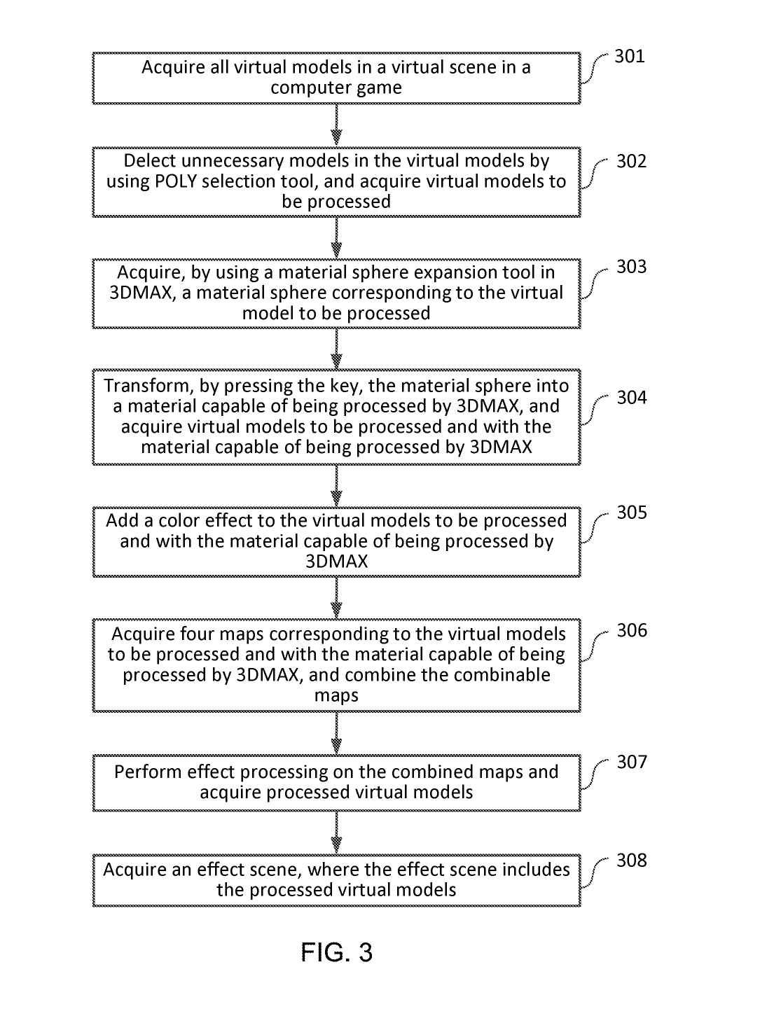

In certain embodiments, there are multiple processes for adding an effect to the virtual scene in the computer game. In one embodiment, the virtual scene in the computer game is processed through 3DMAX software, and then a processed effect scene is obtained. Referring to FIG. 3, a flow chart of adding an effect to a virtual scene in a computer game through 3DMAX software is shown according to one embodiment of the invention. As shown in FIG. 3, the following steps may be included.

At step 301, all virtual models in a virtual scene in a computer game is acquired.

At step 302, unnecessary models in the virtual models are deleted by using POLY selection tool, and virtual models to be processed are acquired.

At step 303, by using a material sphere expansion tool in 3DMAX, a material sphere corresponding to the virtual model to be processed is acquired.

In one embodiment, the material sphere is one property of the virtual model to be processed.

At step 304, by pressing one key, the material sphere transformed into a material capable of being processed by 3DMAX, and then, virtual models to be processed with the material capable of being processed by 3D MAX are acquired.

In one embodiment, the material capable of being processed by 3DMAX is BLINN material.

At step 305, a color effect is added to the virtual models to be processed with the material capable of being processed by 3DMAX.

In one embodiment, by adjusting the material sphere corresponding to the virtual model to be processed, the objective of adding a color effect to the virtual model to be processed is achieved.

At step 306, four maps corresponding to the virtual models to be processed with the material capable of being processed by 3DMAX are acquired, and then the combinable maps are combined.

In one embodiment, the virtual models to be processed correspond to four maps of the following forms: shadowsmap, aomap, lightingmap, and intensitymap. In this embodiment, in order to save the memory resource for storing the maps, the four maps are combined into two maps, where one map including shadowsmap, aomap, intensitymap and the other map including lightingmap are obtained.

At step 307, effect processing is performed on the combined maps, and processed virtual models are acquired.

In one embodiment, effect processing may be performed on the combined map, and then a processed virtual model is acquired. For example, color effect processing of the map may be completed by adjusting the map including lightingmap.

In one embodiment, a splitting tool may be used in advance to unfold the second-layer UV of the virtual model to be processed, and the processed map is added to the second-layer UV, thereby obtaining the processed virtual model.

At step 308, an effect scene is acquired, where the effect scene includes the processed virtual models.

In one embodiment, the processed virtual models are added to the virtual scene, and then an effect scene is obtained.

At step 203, the effect scene is invoked so as to simulate real-time processing of the virtual scene.

This embodiment provides a procedure of simulating real-time processing of a virtual scene in a computer game. Before the virtual scene is invoked, the virtual scene is first acquired. Then, an effect is added to the virtual scene, and an effect scene is acquired subsequently. Finally, the effect scene added with the effect is directly invoked, so as to simulate a real-time processing procedure of the virtual scene. According to the invention, before the virtual scene is invoked, effect processing is performed on the virtual scene in advance according to effect requirements. When the virtual scene is invoked, an effect resulting from real-time processing of the virtual scene is simulated. In certain embodiments, since there is no need for the computer where the computer game is played to perform processing in real time, the computer is not required to have very high performance capability to simulate real-time processing. The virtual scene can be shown smoothly in a computer without very high performance configuration.

Further, this embodiment implements the effect adding to the virtual scene by using 3DMAX. Additionally, the process according to this embodiment groups the virtual models in the virtual scene, thereby improving the efficiency of adding an effect to the virtual scene. Meanwhile, the process combines the maps corresponding to the virtual models, thereby saving the storage resource of the memory.

### Embodiment 3

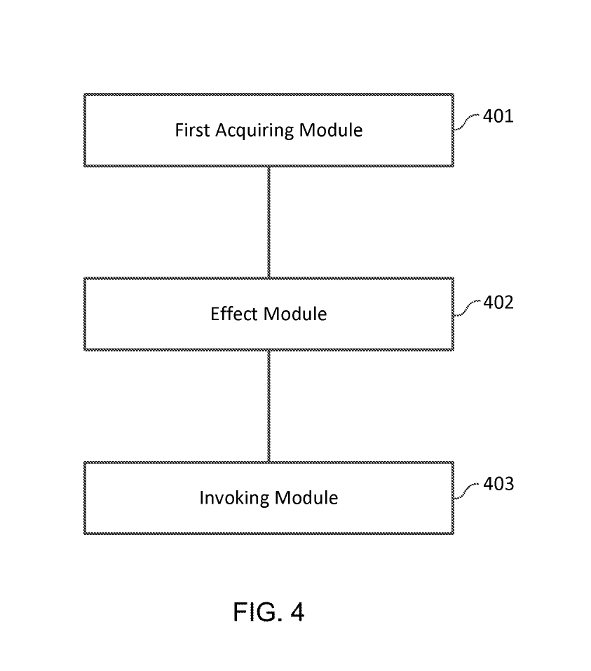

FIG. 4 is a schematic diagram of a system for simulating real-time processing of a virtual scene according to Embodiment 3 of the invention.

Referring to FIG. 4, the system includes a first acquiring module 401, configured to acquire a virtual scene; an effect module 402, configured to add an effect to the virtual scene, and acquire an effect scene; and an invoking module 403, configured to invoke the effect scene, so as to simulate real-time processing of the virtual scene.

Conventionally, an effect parameter value needs to be set for each virtual model in the virtual scene. However, in one embodiment of the invention, in order to improve the efficiency of acquiring the effect scene, the effect module may include a first setting sub-module, configured to uniformly set an effect parameter value for the virtual scene according to requirements; and a first effect sub-module, configured to add an effect to the virtual scene according to the effect parameter value, and acquire an effect scene.

In another embodiment, in order to improve the efficiency of acquiring the effect scene, the effect module may further include a first acquiring sub-module, configured to acquire virtual models in the virtual scene; a second acquiring sub-module, configured to acquire types of the virtual models; a grouping sub-module, configured to group the virtual models according to the types, and then obtain at least one virtual model group; and a second effect sub-module, configured to add an effect to each virtual model in the virtual model group, and then obtain an effect scene.

It should be noted that the processes according to certain embodiments does not limit the method for grouping the virtual models in the virtual scene. Since the effect adding procedure can be simplified by grouping the virtual models, the virtual models can be grouped according to the types of the virtual models. As such, the second effect sub-module may specifically include a third acquiring sub-module, configured to acquire the virtual models in the virtual model group; and a third effect sub-module, configured to add a color effect to the virtual models, and acquire an effect scene.

In another embodiment, the virtual models in the virtual scene are generally stored in the form of multiple maps. Since a large number of maps exist, the maps occupy a large memory. In order to save the memory, the system shown according to certain embodiments may further include a second acquiring module, configured to acquire virtual models in the virtual scene; a third acquiring module, configured to acquire combinable maps corresponding to the virtual models; and a combining module, configured to combine the combinable maps into one map.

In certain embodiments, the system may be applied in a computer game.

In one embodiment, before a virtual scene is invoked, the virtual scene is first acquired. Then, an effect is added to the virtual scene, and an effect scene is acquired subsequently. Finally, the effect scene added with the effect is directly invoked, so as to simulate a real-time processing procedure of the virtual scene. According to the invention, before the virtual scene is invoked, effect processing is performed on the virtual scene in advance according to effect requirements. When the virtual scene is invoked, an effect resulting from real-time processing of the virtual scene is simulated. In certain embodiments, since there is no need for the computer where the computer game is played to perform processing in real time, the computer is not required to have very high performance capability to simulate real-time processing. The virtual scene can be shown smoothly in a computer without very high performance configuration.

It should be noted that the system according to the embodiment is configured to implement the above disclosed method for simulating real-time processing of a virtual scene, so reference is made to the description in the above disclosed method for the relevant content. The system disclosed in the embodiments is merely exemplary. Units described as separate components may be or may not be physically separated. Components shown as units may be or may not be physical units, that is, may be or distributed to a plurality of network units. Some or all of the modules may be selected to achieve the objective of the solution of the embodiment according to actual requirements. One of ordinary skill in the art can understand and implement the present invention without creative efforts.

It should be noted that all or a part of the steps according to the embodiments of the present invention is implemented by hardware or a program instructing relevant hardware. Yet another aspect of the invention provides a non-transitory computer readable storage medium/memory which stores computer executable instructions or program codes. The computer executable instructions or program codes enable a computer or a similar computing apparatus to complete various operations in the above disclosed method for simulating real-time processing of virtual scene. The non-transitory computer readable storage medium/memory may include, but is not limited to, high-speed random access medium/memory such as DRAM, SRAM, DDR RAM or other random access solid state memory devices, and non-volatile memory such as one or more magnetic disk storage devices, optical disk storage devices, flash memory devices, or other non-volatile solid state storage devices.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A method for simulating real-time processing of a virtual scene, comprising:
acquiring a virtual scene;
adding an effect to the virtual scene, and acquiring an effect scene; and
invoking the effect scene so as to simulate real-time processing of the virtual scene.

2. The method according to claim 1, wherein after the step of adding the effect to the virtual scene, the step of acquiring the effect scene comprises:
uniformly setting an effect parameter value for the virtual scene according to requirements; and
adding an effect to the virtual scene according to the effect parameter value, and acquiring the effect scene.

3. The method according to claim 1, wherein after the step of adding the effect to the virtual scene, the step of acquiring the effect scene comprises:
acquiring virtual models in the virtual scene;
acquiring types of the virtual models;
grouping the virtual models according to the types, and obtaining at least one virtual model group; and
adding an effect to each virtual model in the virtual model group, and obtaining the effect scene.

4. The method according to claim 3, wherein after the step of adding the effect to the virtual scene, the step of acquiring the effect scene comprises:
acquiring the virtual models in the virtual model group; and
adding a color effect to the virtual models, and acquiring an effect scene.

5. The method according to claim 1, further comprising:
acquiring virtual models in the virtual scene;
acquiring combinable maps corresponding to the virtual models; and
combining the combinable maps into one map.

6. The method according to claim 1, being applied in a computer game.

7. A system for simulating real-time processing of a virtual scene, comprising:
a first acquiring module, configured to acquire a virtual scene;
an effect module, configured to add an effect to the virtual scene, and acquire an effect scene; and
an invoking module, configured to invoke the effect scene so as to simulate real-time processing of the virtual scene.

8. The system according to claim 7, wherein the effect module comprises:
a first setting sub-module, configured to uniformly set an effect parameter value for the virtual scene according to requirements; and
a first effect sub-module, configured to add an effect to the virtual scene according to the effect parameter value, and acquire the effect scene.

9. The system according to claim 7, wherein the effect module comprises:
a first acquiring sub-module, configured to acquire virtual models in the virtual scene;
a second acquiring sub-module, configured to acquire types of the virtual models;
a grouping sub-module, configured to group the virtual models according to the types, and obtain at least one virtual model group; and
a second effect sub-module, configured to add an effect to each virtual model in the virtual model group, and acquire the effect scene.

10. The system according to claim 9, wherein the second effect sub-module comprises:
a third acquiring sub-module, configured to acquire the virtual models in the virtual model group; and
a third effect sub-module, configured to add a color effect to the virtual model, and acquire the effect scene.

11. The system according to claim 7, further comprising:
a second acquiring module, configured to acquire virtual models in the virtual scene;
a third acquiring module, configured to acquire combinable maps corresponding to the virtual models; and
a combining module, configured to combine the combinable maps into one map.

12. The system according to claim 7, being applied in a computer game.

13. A non-transitory computer-readable medium storing instructions which, when executed by one or more processors, cause a system to perform a method for simulating real-time processing of a virtual scene, the method comprising:
acquiring a virtual scene;
adding an effect to the virtual scene, and acquiring an effect scene; and
invoking the effect scene so as to simulate real-time processing of the virtual scene.

14. The non-transitory computer-readable medium according to claim 13, wherein after the step of adding the effect to the virtual scene, the step of acquiring the effect scene comprises:
uniformly setting an effect parameter value for the virtual scene according to requirements; and
adding an effect to the virtual scene according to the effect parameter value, and acquiring the effect scene.

15. The non-transitory computer-readable medium according to claim 13, wherein after the step of adding the effect to the virtual scene, the step of acquiring the effect scene comprises:
acquiring virtual models in the virtual scene;
acquiring types of the virtual models;
grouping the virtual models according to the types, and obtaining at least one virtual model group; and
adding an effect to each virtual model in the virtual model group, and obtaining the effect scene.

16. The non-transitory computer-readable medium according to claim 15, wherein after the step of adding the effect to the virtual scene, the step of acquiring the effect scene comprises:
acquiring the virtual models in the virtual model group; and
adding a color effect to the virtual models, and acquiring an effect scene.

17. The non-transitory computer-readable medium according to claim 13, the method further comprises:
acquiring virtual models in the virtual scene;
acquiring combinable maps corresponding to the virtual models; and
combining the combinable maps into one map.
